(19) United States
(12) Patent Application Publication
(10) Pub. No.: US 2016/0016400 A1
(43) Pub. Date: Jan. 21, 2016

(54) METHOD FOR EVALUATING A STATUS OF AN INKJET PRINT HEAD

(71) Applicant: OCÉ-TECHNOLOGIES B.V., Venlo (NL)

(72) Inventors: Amol A. KHALATE, Venlo (NL); Johannes M.M. SIMONS, Venlo (NL); Dominicus P.C. JANSSEN, Venlo (NL); Albert G.M. VAN WELIE, Venlo (NL)

(73) Assignee: OCÉ-TECHNOLOGIES B.V., Venlo (NL)

(21) Appl. No.: 14/790,174

(22) Filed: Jul. 2, 2015

(30) Foreign Application Priority Data
Jul. 15, 2014 (EP) 14177097.4

(51) Int. Cl. B41J 2/045

(52) U.S. Cl. CPC B41J 2/04508; B41J 2/04581

(57) ABSTRACT

A method is provided to determine a droplet ejection state of a pressure chamber of a piezo-actuated inkjet print head, the method comprising a step of analyzing that includes filtering a residual pressure wave signal using a predetermined filter. The filter is designed to remove a low-frequency signal contribution generated by piezo material of the piezo actuator. Such a low-frequency signal contribution results from a piezo material property that varies over all piezo actuators without affecting the functional properties of the piezo actuator. Hence, for controlling the operation of the inkjet print head, in particular for controlling a droplet size and a droplet speed, such a signal contribution may be removed enabling a simple and nozzle-independent analysis of the residual pressure wave signal.

### BACKGROUND OF THE INVENTION

1. Field of the Invention

The present invention generally pertains to a method for determining a status of an inkjet print head, in particular the status of a pressure chamber and corresponding nozzle of such an inkjet print head.

2. Description of the Related Art

Inkjet print heads are well known in the art. It is also well known that inkjet print heads may suffer from ejection failures due to dirt in a nozzle. Piezo-actuated print heads may also become unable to eject a droplet due to gas bubbles, usually air bubbles that may have become trapped in a nozzle upon droplet ejection. Such gas bubbles may enter a corresponding pressure chamber. The gas bubbles have a different compressibility compared to a liquid ink and consequently an actuation by the piezo actuator results in a different acoustic wave in the liquid ink. Depending on the size and position of the gas bubble, droplet ejection may fail or may result in a smaller or slower droplet, for example.

It is known to probe the acoustics of the pressure chamber filled with the liquid ink for determining an ejection state of the pressure chamber and corresponding nozzle. Further, it is known to use the piezo actuator as a sensor for probing the acoustics. In such known embodiment, the piezo actuator is first operatively connected to a driving circuit and actuated by the driving circuit by application of a driving pulse to generate a pressure wave in the liquid ink. Subsequently, the actuator is connected to sensing circuit. A residual pressure wave in the liquid ink, resulting from the generated pressure wave, generates a current signal in the piezo actuator. The sensing circuit detects and registers the residual pressure wave. The residual pressure wave is a direct result from the acoustics in the pressure chamber. Hence, suitably analyzing the detected residual pressure wave allows determining the status of the pressure chamber and corresponding nozzle.

It has appeared, however, that the residual pressure waves of fully functional pressure chambers and nozzles may differ from each other. Moreover, the residual pressure waves between print heads of different manufacturing batches may differ to such an extent that a generic analysis of the residual pressure waves appears unreliable. Therefore, a pressure chamber and nozzle specific calibration may be needed. Calibrating each and every pressure chamber is however burdensome and requires complex and expensive circuitry to store and apply any calibration data, when analyzing the corresponding residual pressure waves.

Moreover, the result of the analysis may be employed to adapt a droplet ejection driving pulse to the detected acoustics. For example, it is known that a piezo-electric effect of the actuator may deteriorate over time. Then, using the above-described methods of determining the acoustics allows determining a suitable amplitude adaptation to the driving pulse such to prevent slower and/or smaller droplets due to a too small amplitude of the generated pressure wave in the liquid ink. Due to the sensitivity to differences and tolerances resulting from manufacturing, the drive pulse amplitude may be adapted inaccurately or even erroneously. Consequently, an incorrect droplet may be ejected from the nozzles, if a standard calibration process would be performed on individual nozzles, unless such calibration process would include measuring a size of an expelled droplet for each nozzle. Such a calibration process is practically unfeasible. It is therefore desirable to have a method for determining an ejection status of each pressure chamber that is insensitive to manufacturing differences and tolerances.

### SUMMARY OF THE INVENTION

In an aspect of the present invention, a method to determine a droplet ejection state of a pressure chamber of an inkjet print head is provided. When performing the method, the pressure chamber is filled with an ejection liquid. Further, a piezo actuator is arranged for generating a pressure wave in the ejection liquid. The method includes the steps of:
a. generating a pressure wave in the ejection liquid using the piezo actuator;
b. detecting a residual pressure wave in the ejection liquid in the pressure chamber using the piezo actuator, thereby generating a residual pressure wave signal; and
c. analyzing the residual pressure wave signal to determine acoustics of the pressure chamber.

In accordance with the present invention, the step of analyzing includes filtering the residual pressure wave signal using a predetermined filter. The filter is designed to remove a signal contribution generated by piezo material of the piezo actuator, such that a behavior relating to a droplet size and a droplet speed may be determined from the filtered signal.

It has appeared that the specific piezo material of each actuator may have a significant contribution to the residual pressure wave signal. In other words, the residual pressure wave signal has appeared to have more contributions than only the actual residual pressure wave. More in particular, the specific piezo-electric material used for the piezo actuator may exhibit properties that significantly influence the residual pressure wave signal. Research has revealed that a large contribution results from a rate of discharge of residual electric charge in the piezo material. Significant variations in this rate of discharge have appeared to occur even within a single block of piezo material used for the actuators of a single print head, which provides a significant difficulty in determining the actual acoustics of each pressure chamber.

On the other hand, the rate of discharge provides a low frequency contribution to the residual pressure wave signal. The acoustics of the pressure chamber of an inkjet print head is usually determined by higher frequency contributions. Considering the actual acoustic frequencies of the pressure chamber allows designing a suitable high-pass filter to remove the signal contributions stemming from the piezo material of the piezo actuator.

Thus, the method according to the present invention removes a low-frequency signal contribution that results from a piezo material property which may vary over all piezo actuators, but which does not affect the functional properties of the piezo actuator. Hence, for controlling the operation of the inkjet print head, such a signal contribution may be removed thereby enabling a simple and nozzle-independent analysis of the residual pressure wave signal.

In an embodiment, the filter is a band-pass filter, not only removing the low frequency contribution from the piezo material, but also removing high-frequency contributions from noise and/or other piezo actuator properties such as a resonant mode frequency of the actuator.

In an embodiment, the filtering is performed in the time-domain using a FIR filter, wherein the FIR filter is designed to let the frequency contributions from the acoustics pass. The FIR filter order can be suitably selected to obtain a desired attenuation of the disturbing frequency signal contribution, provided that the order of the FIR filter remains smaller than the number of samples of the residual pressure wave signal as well known to those skilled in the art.

Other methods of filtering are also known in the art and may be employed as well. However, filtering in the time domain prevents time-consuming Fourier transformation of the residual pressure wave signal and is easy to implement.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying schematical drawings which are given by way of illustration only, and thus are not limitative of the present invention, and wherein:

FIG. 1A is a graph illustrating residual pressure wave signals from a number of pressure chambers of a single print head;

FIG. 1B is a graph illustrating the frequency contributions in the residual pressure wave signals of FIG. 1A;

FIG. 1C is a graph illustrating the frequency contributions in the residual pressure wave signals of FIG. 1A after filter in accordance with the present invention;

FIG. 2 is a graph illustrating a metric derived from the residual pressure wave signals of FIG. 1A with and without filtering in accordance with the present invention;

FIG. 3A is a graph illustrating an embodiment of a FIR filter for use in the present invention;

FIG. 3B is a graph illustrating the frequency contributions in the FIR filter of FIG. 3A; and

FIG. 4 is a graph illustrating frequency contributions possibly present in an exemplary residual pressure wave signal.

### DETAILED DESCRIPTION OF THE EMBODIMENTS

The present invention will now be described with reference to the accompanying drawings.

The present invention relates to a method of detecting a residual pressure wave in an inkjet print head pressure chamber. A known inkjet print head is provided with a pressure chamber that is fluidly connected to a nozzle. A piezo actuator is arranged at a flexible wall of the pressure chamber. The piezo actuator may deform upon application of a voltage pulse. Due to the deformation of the piezo actuator, a pressure wave is generated in a liquid that is present in the pressure chamber. The pressure wave in the liquid results in a droplet of the liquid being expelled through the nozzle. Further, after having generated the pressure wave, a residual pressure wave remains in the liquid and such residual pressure wave dampens over time. The residual pressure wave in the liquid affects the piezo actuator and as a result an electrical signal can be derived from the piezo actuator. The shape of the thus derived residual pressure wave signal is determined by the acoustics in the pressure chamber. Therefore, analysis of the residual pressure wave signal provides information regarding the acoustics in the pressure chamber. Such a method and corresponding print head device is known in the art and a particular embodiment is, for example, in detail described in EP1013453. Therefore, the print head device and corresponding residual pressure wave detection and analysis method is not elucidated in more detail herein.

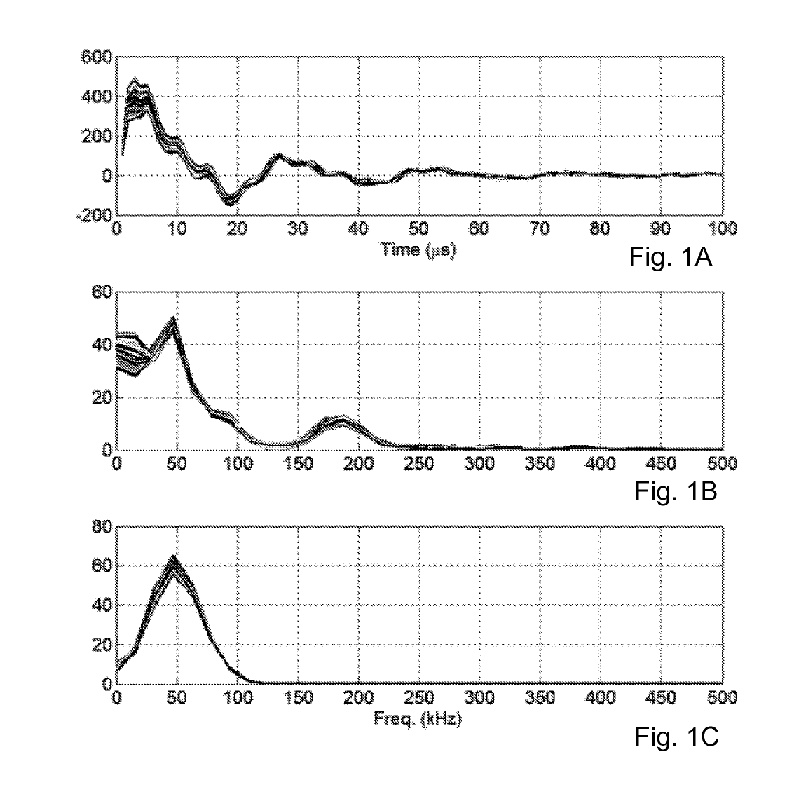

Now referring to FIG. 1A, a graph is shown, the horizontal axis representing time (microseconds) and the vertical axis representing amplitude (arbitrary units). The graph shows a number of residual pressure wave signals obtained in accordance with the known above-described prior art. In particular, the residual pressure wave signal are obtained from a number of pressure chambers of a single print head. All nozzles eject droplets of an ink correctly, so it is determined that all residual pressure wave signals correspond to fully operational, i.e. not failing or otherwise malfunctioning, nozzles and corresponding pressure chambers and piezo actuators. Still, in particular in the period from 0 to 50 microseconds after start of the residual pressure wave signal sensing, a significant variation in the signal amplitude is visible. Still, the actuators and other elements of the pressure chambers and nozzles of this print head are manufactured from the same materials. No variations would be expected.

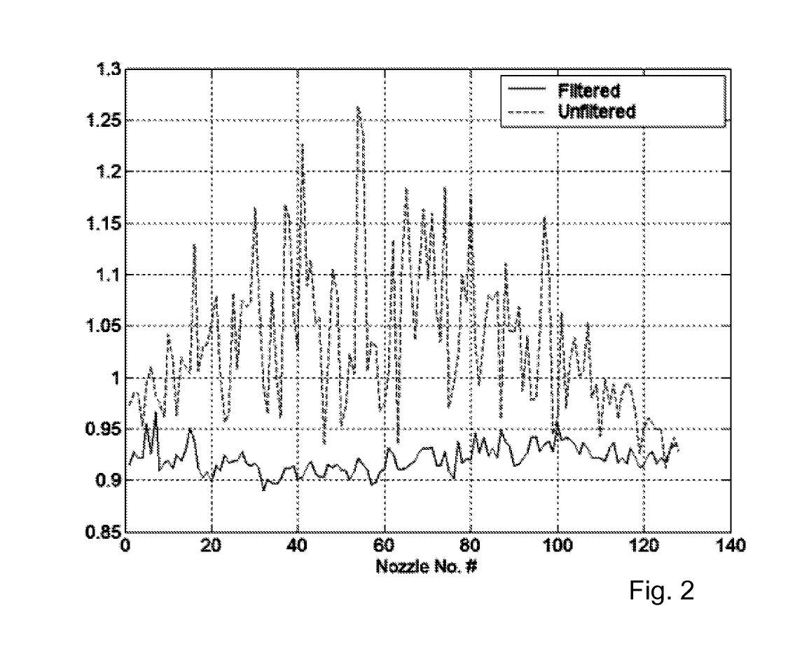

These residual pressure wave signals may be used for calibration purposes. For example, a drive pulse amplitude may be adapted to a certain metric derivable from the residual pressure wave signal such to obtain a predetermined and desired droplet size and/or droplet speed. Still, despite this variation, all droplets expelled by this print head have a similar size and speed. Hence, it has appeared that it is impossible to define a metric that can be suitably and accurately used to determine a drive pulse amplitude for every piezo actuator of this print head. As an example, in FIG. 2, which is elucidated in more detail herein below, a dashed line illustrates the variation in such a metric.

FIG. 1B shows a frequency graph corresponding to FIG. 1A, i.e. the horizontal axis represents frequency (kHz) and the vertical axis represents a frequency contribution (arbitrary units). FIG. 1B may be obtained by performing a Fourier transformation on the data underlying FIG. 1A. As apparent from FIG. 1B, a major difference between the different residual pressure wave signals is resulting from a difference in a low frequency contribution. In a range from about 0 to about 30 kHz, the variation is particularly large. Upon considering the theoretical acoustics of a pressure chamber of the specific print head, it appeared that the acoustics of this particular print head lies in a range from about 30 to about 80 kHz. Hence, a filter for removing the low frequency contributions would enable to remove the variations significantly. Application of a suitable filter, i.e. a filter suppressing the residual pressure wave signal contributions having a frequency of up to about 30 kHz, will remove such variations. Further, it may be considered to remove at the same time any frequency contributions above the upper frequency of the acoustics, in this case above about 80 kHz. Indeed, as illustrated in FIG. 1C, application of such a filter results in a well-defined distribution of the frequency contributions in the filtered residual pressure wave signals. Deriving the corresponding metrics from these filtered residual pressure wave signals results in the solid line illustrated in FIG. 2.

As above indicated, FIG. 2 shows a graph illustrating a metric derivable from the residual pressure wave signal and used for determining a suitable drive pulse amplitude. On the horizontal axis, the nozzles are represented and the vertical axis represents a normalized metric value. The dashed curve in the graph represents the metric values for each nozzle derived from the original, unfiltered residual pressure wave signals. As apparent, the metric values of the separate nozzles range from about 0.94 to about 1.26 (i.e. the highest value is 34% higher than the lowest value, although both expel droplets of similar size and having a similar speed, when actuated with a same drive pulse. Actuating with a drive pulse with an amplitude difference corresponding to the difference in metric will surely result in different droplet size and speed and is clearly not appropriate. Filtering the residual pressure waves in accordance with the present invention and then calculating the exemplary relevant metric, results in the solid curve. The solid curve only varies in a range between about 0.9 and about 0.96, i.e. a variation of only about 6%.

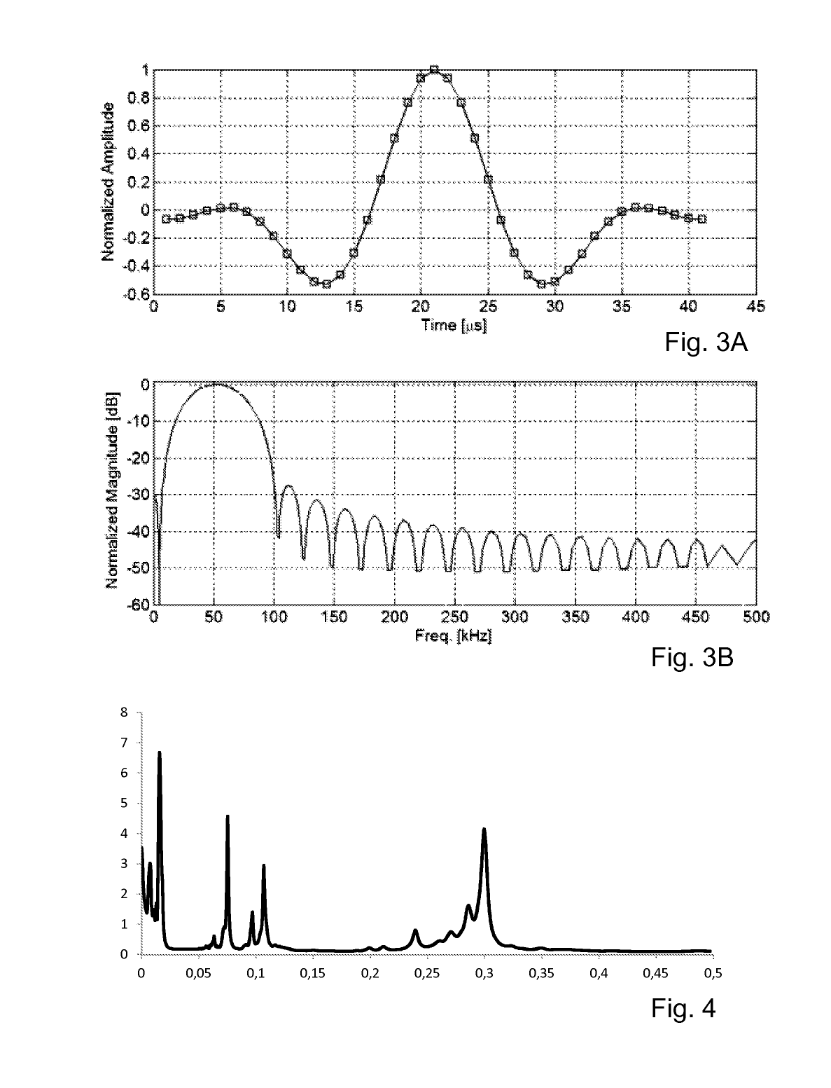

FIGS. 3A and 3B illustrate an exemplary FIR filter for use in the present invention. FIG. 3A illustrates the FIR filter in the time domain. The horizontal axis represents time (microseconds) and the vertical axis represents a normalized amplitude. The illustrated FIR filter has an order 41, i.e. consists of 41 samples. FIG. 3B illustrates an effect of the filter illustrated in FIG. 3A in the frequency domain. The horizontal axis represents frequency (kHz) and the vertical axis represents a normalized magnitude of damping (dB). In FIG. 3B, a damping of the FIR filter for each frequency is shown. So, for example, at about 55 kHz, the damping of the FIR filter is about 0 dB (i.e. no damping) and at about 105 kHz, the damping is about −40 dB. In general, when applied to the residual pressure wave signal, this exemplary FIR filter significantly damps any signal frequencies outside a range of about 30-80 kHz. As apparent to those skilled in the art of designing signal filters, increasing the order of the FIR filter may provide sharper boundaries between the damped and undamped signal frequencies and/or better damping of frequencies outside the indicated frequency range. Similarly, depending on the desired accuracies and circumstances, a lower order of the FIR filter may be selected.

The FIR filter as illustrated in FIGS. 3A and 3B is designed to damp signal frequencies outside the range of 30-80 kHz. However, suitability of a signal filter depends on the print head used. So, the exemplary FIR filter is suitable for use with a print head having acoustic resonance frequencies in the indicated range of 30-80 kHz. Other print heads may have a different acoustic resonances frequency range. For example, in particular MEMS-based piezo inkjet print heads having smaller pressure chambers usually have significantly higher acoustic resonance frequencies. In such cases the filter needs to be adapted and designed to allow such acoustic resonance frequencies to pass and to damp any signal frequencies outside such specific acoustic resonance frequency range.

The FIR filter as illustrated in FIGS. 3A and 3B is suitable to filter a residual pressure wave signal in the time domain as a moving-average filter. Such a filter allows simple and cost-effective filtering of the residual pressure wave signal. Depending on the application and required accuracies and level of damping, other kind of filtering may be contemplated. In particular, filtering in the frequency domain may be desirable, if sufficient time and computational power is available.

Referring to FIG. 4, an acoustic resonance spectrum of an exemplary piezo-actuated inkjet print head is provided. The horizontal axis represents frequency divided by a sampling frequency (hence, unit free) and the vertical axis represents amplitude (in arbitrary units). A relatively high sampling frequency is employed to generate the acoustic resonance spectrum of FIG. 4. Therefore, the acoustic resonance frequencies of the pressure chamber are present in the range between 0 and about 0.02. The resonance peaks in the range between about 0.07 and 0.31 are mechanical resonance frequencies of the piezo actuator. Thus, it is apparent from FIG. 4 that, if applying a suitably high sampling frequency and using suitable filtering, it is enabled to derive a piezo-actuator status by employing the method according to the present invention. Such piezo-actuator status derivable from the resonance spectrum includes piezo-actuator properties resulting from placement (e.g. relative to the pressure chamber), adherence properties, such as gluing properties, and the like. The method according to the present invention is therefore also highly suitable to determine the piezo-actuator properties and determine any faults in the piezo-actuator in a non-destructive way.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A method to determine a droplet ejection state of a pressure chamber of an inkjet print head, wherein the pressure chamber is filled with an ejection liquid and a piezo actuator is arranged for generating a pressure wave in the ejection liquid, the method including:
a. generating a pressure wave in the ejection liquid using the piezo actuator;
b. detecting a residual pressure wave in the ejection liquid in the pressure chamber using the piezo actuator, thereby generating a residual pressure wave signal;
c. analyzing the residual pressure wave signal to determine acoustics of the pressure chamber;
wherein the step of analyzing includes filtering the residual pressure wave signal using a predetermined filter, the filter being designed to remove a low-frequency signal contribution generated by piezo material of the piezo actuator, such that a behavior relating to a droplet size and a droplet speed may be determined from the filtered signal.

2. The method according to claim 1, wherein the step of filtering includes using a FIR filter and filtering the residual pressure wave signal in the time-domain.

3. The method according to claim 1, wherein the step of filtering includes using a band-pass filter to filter both undesired low-frequency contributions and undesired high-frequency contributions.

4. The method according to claim 1, wherein the step of analyzing includes analyzing high-frequency contributions, which high-frequency contributions correspond to mechanical resonance frequencies of the piezo-actuator for determining a status of the piezo-actuator.
